(19) United States
(12) Patent Application Publication
(10) Pub. No.: US 2021/0404874 A1
(43) Pub. Date: Dec. 30, 2021

(54) Software Defined Lighting

(71) Applicant: Airmar Technology Corporation, Milford, NH (US)

(72) Inventors: Didier Caute, Lorient (FR); Bruno Marie, Ploemeur (FR); Brice Godreul, Ploemeur (FR)

(21) Appl. No.: 17/357,564

(22) Filed: Jun. 24, 2021

Related U.S. Application Data
(60) Provisional application No. 63/043,608, filed on Jun. 24, 2020.

(51) Int. Cl. G01J 3/10; H05B 47/105; G01J 3/42; G01J 3/02

(52) U.S. Cl. CPC G01J 3/10; G01J 3/0297; G01J 3/42; H05B 47/105

(57) ABSTRACT

A multi-function imaging system comprises a light sensor and a software defined light source to enable real-time automatic adjustment of various parameters of the one or more light sources. The system is realized in a single unit, or as multiple co-located units, thus reducing the cost of having such multiple functions. The system is capable of self-calibrating in the field to enable accurate imaging.

### RELATED APPLICATION

This application claims the benefit of U.S. Provisional Application No. 63/043,608, filed on Jun. 24, 2020. The entire teachings of the above application are incorporated herein by reference.

### BACKGROUND

Cameras are frequently used to monitor fishing equipment and to track fish. However, light absorption in an aquatic environment can depend on many factors, including salinity, pollution, distance to the object being imaged, and wavelength of light. Such a dynamic light absorption characteristic presents numerous challenges when attempting to capture images underwater.

### SUMMARY

The fishing industry lacks existing software defined light sources that address all of the major challenges associated with light absorption in an aquatic medium and function as a single-unit imaging system together with a light sensor.

In one embodiment, a method of performing one of a plurality of applications includes illuminating one or more physical objects with one or more light sources, and sensing light reflected by the one or more physical objects with a light sensor. The method includes automatically adjusting, at a computer processor, one or more parameters of the one or more light sources based on video data received from the light sensor. The adjustment of the one or more parameters of the one or more light sources may depend on data retrieved from a non-transitory computer-readable data storage medium by the computer processor, the data having been generated from one or more previous observations.

In some embodiments, the one or more parameters of the one or more light sources include intensity. The one or more parameters of the one or more light sources may include spectrum. The spectrum may be adjusted to control white balance for the light sensor operating in one of a plurality of media with a static or dynamic absorption characteristic. The one of a plurality of media may include water or a water-based solution. The water-based solution may include salt water. The spectrum may be adjusted to influence the behavior of the one or more physical objects, or to avoid influencing the behavior of the one or more physical objects.

In some embodiments, the one or more light sources may be automatically adjusted to produce one of a plurality of pre-defined patterns of light. The one of a plurality of pre-defined patterns of light may include a grid. The method may further include configuring a computer processor to analyze the sensed light data corresponding to a reflection of the grid from the one or more physical objects to determine a contour of the one or more physical objects. The one of a plurality of pre-defined patterns of light may include a checkerboard pattern. The method may further include configuring a computer processor to analyze the sensed light data corresponding to a reflection of the checkerboard pattern from the one or more physical objects to facilitate calibration of the light sensor.

In another embodiment, a system includes one or more light sources configured to illuminate one or more physical objects and a light sensor configured to sense light reflected by the one or more physical objects. The system may include a computer processor configured to automatically adjust one or more parameters of the one or more light sources based on video data received from the light sensor.

In some embodiments, the one or more light sources may each be configured to produce a beam of light having component wavelengths in each of the red, green, and blue regions of the visible light spectrum. The system may include one or more prisms configured to disperse the beam of light by wavelength, direct a portion of the dispersed beam of light having wavelengths in the red region of the visible light spectrum to one or more digital micro-mirror devices, direct a portion of the dispersed beam of light having wavelengths in the green region of the visible light spectrum to one or more digital micro-mirror devices, direct a portion of the dispersed beam of light having wavelengths in the blue region of the visible light spectrum to one or more digital micro-mirror devices, and to direct the beam reflected by each one or more digital micro-mirror devices to a projection lens.

In some embodiments, at least one light source may be configured to produce a beam of light having wavelengths in the red region of the visible light spectrum, at least one light source may be configured to produce a beam of light having wavelengths in the green region of the visible light spectrum, and at least one light source may be configured to produce a beam of light having wavelengths in the blue region of the visible light spectrum. The system may include one or more prisms configured to direct the beam produced by each light source to one or more digital micro-mirror devices, and to direct the beam reflected by the one or more digital micro-mirror devices to a projection lens.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 illustrates a single light source architecture of a software-defined light source imaging system, according to some embodiments of the present disclosure.

FIG. 2 illustrates a multiple light source architecture of a software-defined light source imaging system, according to some embodiments of the present disclosure.

FIG. 3 is a flow diagram, illustrating an example method (or system) according to some embodiments of the present disclosure.

FIG. 4 illustrates a computer network (or apparatus, or system) or similar digital processing environment, according to some embodiments of the present disclosure.

FIG. 5 illustrates a diagram of an example internal structure of a computer (e.g., client processor/device or server computers) in the computer system (and apparatus) of FIG. 4, according to some embodiments of the present disclosure.

### DETAILED DESCRIPTION

A description of example embodiments follows.

The methods described below create an optimized field of light for illuminating one or more physical objects 100 to be imaged by a light sensor 41. In some embodiments, the light sensor 41 may be comprised of one or more semiconductor-based photodetectors, charge-coupled devices, or other light-sensing devices known in the art. In some embodiments, the light sensor 41 may include still image capturing or video recording digital camera devices. The optimization may include an analysis of video data received at the light sensor as initially illuminated. The optimization may further include adjustments to one or more parameters 508 of one or more light sources based on the analysis. The optimization improves one or more aspects of the quality of the video data received at the light sensor 41. In some embodiments, the one or more physical objects 100 may include fish.

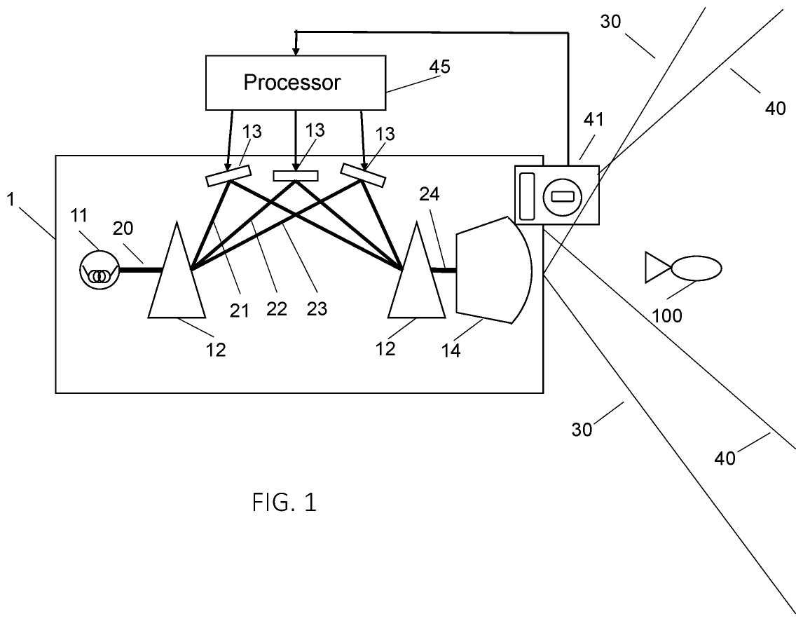

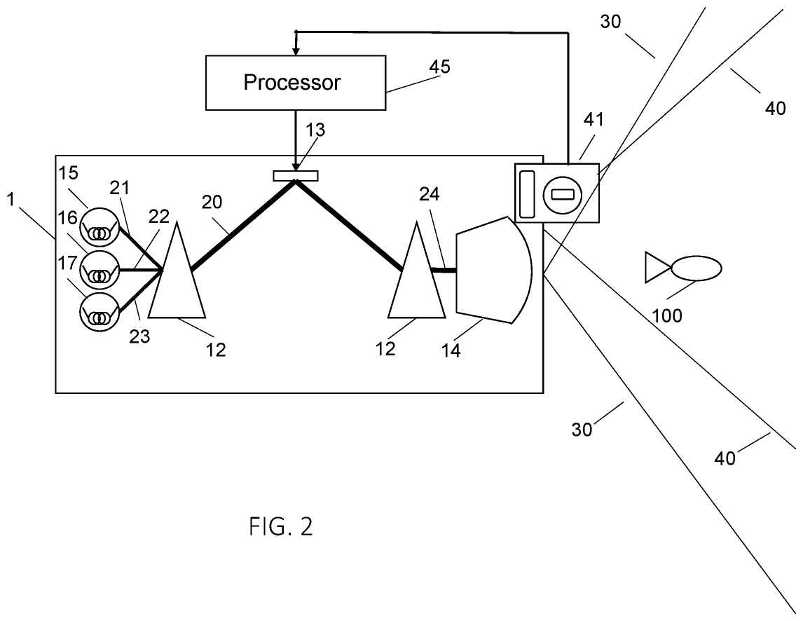

Turning now to FIGS. 1-2, a software-defined light source imaging system is generally denoted by numeral 1 and will hereinafter be referred to as the “system 1.”

FIG. 1 illustrates an embodiment of the system 1 comprising a single white light source 11 configured to produce a beam of light 20 having component wavelengths in each of the red, green, and blue regions of the visible light spectrum. In FIG. 1, a pair of prisms 12 is shown to be capable of dispersing the beam of light 20 by wavelength into separate component beams. Three distinct component beams may be created, namely, a red beam 21, a green beam 22, and a blue beam 23. The red beam 21, the green beam 22, and the blue beam 23 may each be directed to one or more digital micro-mirror devices (DMDs) 13. The pair of prisms 12 is also capable of combining the component beams reflected by the DMDs to create a beam of light 24 having component wavelengths in each of the red, green, and blue regions of the visible light spectrum. The beam of light 24 may be directed to a projection lens 14, creating a pattern of light 30 that illuminates the field of view 40 of the light sensor 41, enabling the light sensor 41 to sense the one or more physical objects 100. A computer processor 45 may analyze the video data provided by the light sensor 41 and configure the DMDs 13 to modify one or more parameters of the component beams reflected by the DMDs, thus modifying one or more parameters of the beam 24.

FIG. 2 illustrates another embodiment of the system 1 comprising at least one red light source 15, at least one green light source 16, and at least one blue light source 17. Each one of the red light source 15, the green light source 16, and the blue light source 17 may be configured to produce a beam of light having wavelengths in a region of the visible light spectrum corresponding to its color, namely, a red beam 21, a green beam 22, and a blue beam 23, respectively. In FIG. 2, a pair of prisms 12 is shown to be capable of combining the red beam 21, the green beam 22, and the blue beam 23 into a beam of light 20 having component wavelengths in each of the red, green, and blue regions of the visible light spectrum. The beam of light 20 may be directed to one or more DMDs 13. The beam reflected by the one or more DMDs 13 may pass through at least one of the pair of prisms 12 to create a beam of light 24 having component wavelengths in each of the red, green, and blue regions of the visible light spectrum. The beam of light 24 may be directed to a projection lens 14, creating a pattern of light 30 that illuminates the field of view 40 of the light sensor 41, enabling the light sensor 41 to sense the one or more physical objects 100. A computer processor 45 may analyze the video data provided by the light sensor 41 and configure the one or more DMDs 13 to modify one or more parameters of the beam reflected by the one or more DMDs, thus modifying one or more parameters of the beam 24. The computer processor 45 may be an embedded unit residing in a device that also encompasses the light sensor 41 or any other component of the system 1.

FIGS. 1 and 2 are not drawn to scale. The projection lens 14 may be located close to the light sensor 41, and oriented in the same direction, to completely illuminate the field of view 40 and the one or more physical objects 100.

In some embodiments, one or more prisms may be configured to disperse the beam of light 20 by wavelength. In some embodiments, the one or more prisms may be configured to direct a portion of the dispersed beam of light having wavelengths in the red region 21 of the visible light spectrum to the one or more DMDs 13, direct a portion of the dispersed beam of light having wavelengths in the green region 22 of the visible light spectrum to one or more DMDs 13, direct a portion of the dispersed beam of light having wavelengths in the blue region 23 of the visible light spectrum to the one or more DMDs 13. In some embodiments, the one or more prisms may be configured to direct the beams 21, 22, and 23 produced by each of the red 15, green 16, and blue 17 light sources to the one or more DMDs 13. In some embodiments, the one or more prisms may be a pair of prisms as represented by the pair of prisms 12 in FIGS. 1-2. In some embodiments, the one or more prisms may include one or more singular or compound prisms.

In some embodiments, the one or more DMDs 13 may be comprised of many microscopic mirrors that, upon reflection of a beam of light that is continuous across a portion of a plane perpendicular to the propagation of the beam, create an array of smaller beams corresponding to the number of mirrors on each DMD 13. The mirrors on the one or more DMDs 13 can be individually controlled by the computer processor 45 to reflect light so that, after passing through the one or more prisms, the light may either pass through or bypass the projection lens 14.

In some embodiments, beam arrays may include thousands or millions of beams, or more. Examples of DMD resolution may include 1920×1080 and 3840×2160. In some embodiments, the light sensor 41 may acquire video data at a rate of 30 frames per second. DMDs are fast enough to allow the one or more parameters 508 of the one or more light sources to be adjusted on every image capture in a 30 frame per second system. In some embodiments, the one or more DMDs 13 may allow the one or more parameters 508 of the one or more light sources to be adjusted up to 200 times per second. It should be understood that the given resolutions, frame rates, and light source adjustment rates are exemplary, and that they can have other values.

As can be appreciated, the system 1 includes various hardware components that can be configured to perform various functions using firmware that either resides in the system 1 upon initial programming, or is downloaded at a later time, e.g. to upgrade the system 1 to utilize additional functions.

For simplicity, FIGS. 1 and 2 show a single beam per DMD device. However, in practice, as multiple beams may be produced by a single DMD device and individually imaged by the light sensor 41, embodiments enable control of a full area of illumination based on data received from the light sensor or obtained from a model of expected behavior, such as absorption, of light in a medium. Such control may be exercised individually over each beam making up the illuminated area.

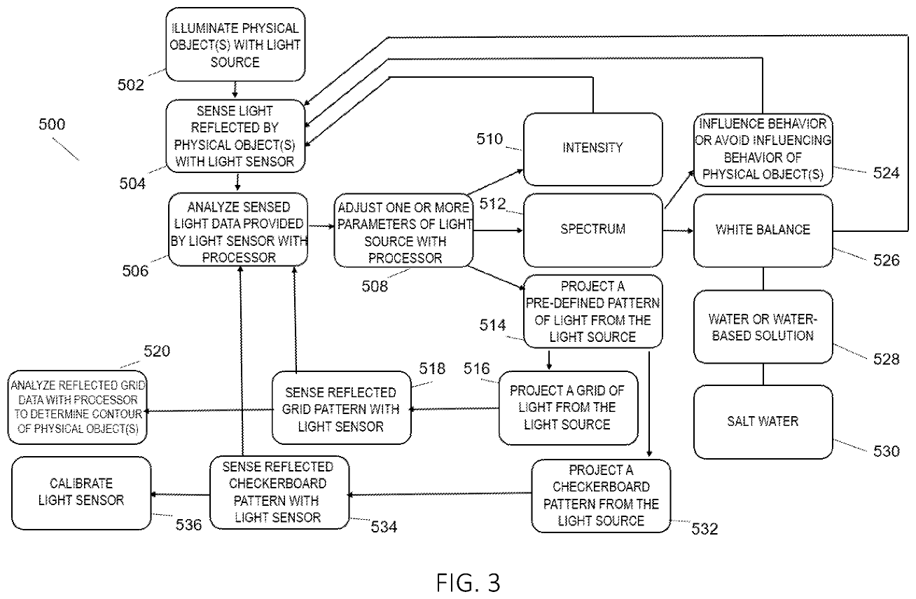

FIG. 3 is a flow diagram illustrating an example method 500, according to some embodiments of the present disclosure. As illustrated in FIG. 3, in some embodiments, the method includes illuminating 502 the one or more physical objects 100 with one or more light sources. The method includes sensing 504 light reflected by the one or more physical objects 100 with the light sensor 41. The method includes configuring the computer processor 45 to automatically adjust one or more parameters 508 of the one or more light sources. The adjustment of the one or more parameters 508 of the one or more light sources may be based on an analysis of the sensed light 506, the analysis performed by the computer processor 45. Although not shown in FIG. 3, the adjustment of the one or more parameters 508 of the one or more light sources may depend on data retrieved from a non-transitory computer-readable data storage medium by the computer processor 45, the data having been generated from one or more previous observations. The adjustment of the one or more parameters 508 of the one or more light sources may thus combine known characteristics of a medium, such as a spectral absorption profile of water, with real-time feedback obtained from the light sensor 41, to achieve a desired illumination profile for the subject physical objects 100.

As illustrated in FIG. 3, in some embodiments, the one or more parameters 508 of the one or more light sources may include intensity 510.

The processor 45 may be configured to adjust the intensity 510 to account for absorption of light. In some embodiments, the system 1 may operate in one of a plurality of media with a spatially non-uniform absorption characteristic for the plane perpendicular to the propagation of the beam of light. In some embodiments, the one or more physical objects 100 may be located at different distances from the one or more light sources, subjecting each beam of light illuminating the one or more physical objects 100 to a different level of absorption based on the distance it must travel through the medium to reach the target. The system 1, by individually controlling the mirrors on the one or more DMDs 13 with the computer processor 45, addresses the challenges denoted in each of the two previously mentioned embodiments by analyzing each pixel of video data received at the light sensor 41 and controlling each mirror on the one or more DMDs 13 to create a spatially uniform field of illumination across the surface of the one or more physical objects 100.

The processor 45 may be configured to adjust the intensity 510 to account for reflectivity of the one or more physical objects 100. In some embodiments, the one or more physical objects 100 may be characterized by a wide range of reflectivity, both across the surface of the one or more physical objects, as well as depending upon the angle of incidence of the illuminating ray. The system 1, by individually controlling the mirrors on the one or more DMDs 13 with the computer processor 45, can adjust the intensity across the field of illumination to avoid exceeding a saturation threshold of the light sensor 41 in the event that the one or more physical objects 100 are highly reflective. The capability of the system 1 to avoid light sensor saturation is especially advantageous in embodiments wherein the one or more physical objects are fish in an underwater environment.

As illustrated in FIG. 3, in some embodiments, the one or more parameters 508 of the one or more light sources may include spectrum 512.

The processor 45 may be configured to adjust the spectrum 512 to influence the behavior of or to avoid influencing the behavior 524 of the one or more physical objects 100. In embodiments wherein the one or more physical objects 100 are fish in an aquatic medium, the processor 45 may be configured to adjust the spectrum 512 to attract or deter various species of fish. For example, light wavelengths in the blue and green regions of the spectrum can be used to attract or deter various species based on previously observed behavioral characteristics of the species given the wavelength of light and environmental conditions. In another example, light wavelengths in the red region of the spectrum can be used to capture images of fish without changing their behavior, as fish have generally been found to be less sensitive to red light. The capability of the system 1 to capture images of fish without influencing their behavior is especially useful when tracking gamefish currently engaged in a predictable pattern of hunting baitfish. Using red light, the gamefish can be tracked and more easily caught without being distracted by light having wavelengths to which they are more sensitive.

The processor 45 may be configured to adjust the spectrum 512 to control white balance 526 for the light sensor 41. In some embodiments, the system 1 may operate in one of a plurality of media with a static or dynamic absorption characteristic. The one of a plurality of media may include water or a water-based solution 528. The water-based solution may include salt water 530. The salt water medium may include but is not limited to sea water found in a marine environment, brackish water found inland or close to shore, or a controlled solution found in an artificial environment such as a laboratory. In embodiments wherein the water or water-based solution includes fresh water or salt water in an uncontrolled environment, the ability to control white balance is particularly advantageous due to the fact that various properties of the underwater environment can significantly affect light absorption. For example, brackish or coastal water generally absorbs more strongly than clear seawater. The difference is greatest for shorter wavelengths, i.e., in the violet region, and the difference is smallest in the orange region. As another example, polluted seawater generally has a wavelength-dependent absorption characteristic between that of brackish water and clear seawater, except for a wavelength region between orange and red, where polluted seawater absorbs even more strongly than brackish water. In an uncontrolled environment, or while attached to a vessel moving from coastal to offshore waters, the absorption characteristic of the medium can change significantly during use of the system 1. The system 1 therefore provides significant value in enabling an active control of light sensor white balance.

As illustrated in FIG. 3, in some embodiments, the one or more parameters 508 of the one or more light sources may comprise the projection of a pre-defined pattern of light 514 from the one or more light sources.

In some embodiments, the pre-defined pattern of light 514 may be comprised of a grid of light 516. The method may include sensing the reflected grid pattern 518 with the light sensor 41. The method may include configuring the computer processor 45 to analyze the reflected grid pattern to determine the contour 520 of the one or more physical objects 100. In some embodiments, the one or more physical objects may include the ocean floor or the bottom of a coastal or inland body of water.

In some embodiments, the pre-defined pattern of light 514 may be comprised of a checkerboard pattern 532. The method may include sensing a reflected checkerboard pattern 534 with the light sensor 41 to facilitate calibration 536 of the light sensor 41. The calibration 536 of the light sensor 41 may include a positional calibration. The methods may further include configuring the processor 45 to automatically adjust the one or more parameters 508 of the one or more light sources based on video data received from the light sensor 41.

In some embodiments, the single white light source 11 may be comprised of a blue laser module paired with a phosphor reflector. This pairing offers high intensity, stability, and a long lifetime particularly suited to embodiments that require constant underwater use.

In some embodiments, the at least one red light source 15, the at least one green light source 16, and the at least one blue light source 17 may be comprised of lasers or LEDs.

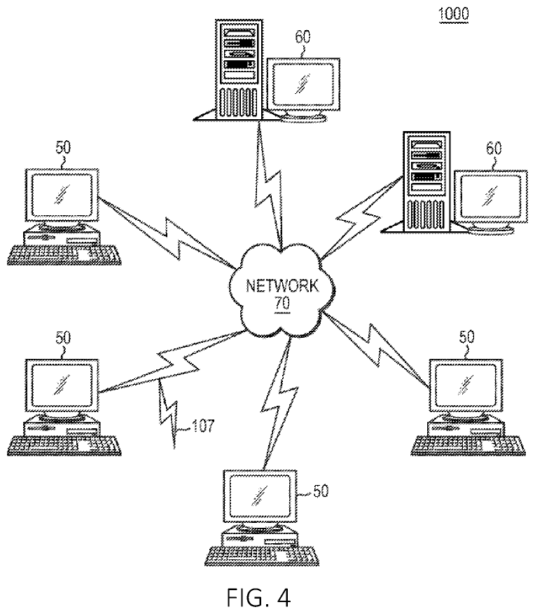

FIG. 4 illustrates a computer network (or system) 1000 or similar digital processing environment, according to some embodiments of the present disclosure. Client computer(s)/devices 50 and server computer(s) 60 provide processing, storage, and input/output devices executing application programs and the like. The client computer(s)/devices 50 can also be linked through communications network 70 to other computing devices, including other client devices/processes 50 and server computer(s) 60. The communications network 70 can be part of a remote access network, a global network (e.g., the Internet), a worldwide collection of computers, local area or wide area networks, and gateways that currently use respective protocols (TCP/IP, Bluetooth®, etc.) to communicate with one another. Other electronic device/computer network architectures are suitable.

Client computers/devices 50 may be configured with a computing module (located at one or more of elements 50, 60, and/or 70). In some embodiments, a user may access the computing module executing on the server computers 60 from a user device, such a mobile device, a personal computer, or any computing device known to one skilled in the art without limitation. According to some embodiments, the client devices 50 and server computers 60 may be distributed across a computing module.

Server computers 60 may be configured as the computing modules which communicate with client devices 50 for providing access to (and/or accessing) databases that include data associated with light reflected by one or more physical objects. The server computers 60 may not be separate server computers but part of cloud network 70. In some embodiments, the server computer (e.g., computing module) may enable users to adjust parameters of one or more light sources by allowing access to data located on the client 50, server 60, or network 70 (e.g., global computer network). The client (configuration module) 50 may communicate data representing the light reflected by one or more physical objects back to and/or from the server (computing module) 60. In some embodiments, the client 50 may include client applications or components executing on the client 50 for adjusting parameters of one or more light sources, and the client 50 may communicate corresponding data to the server (e.g., computing module) 60.

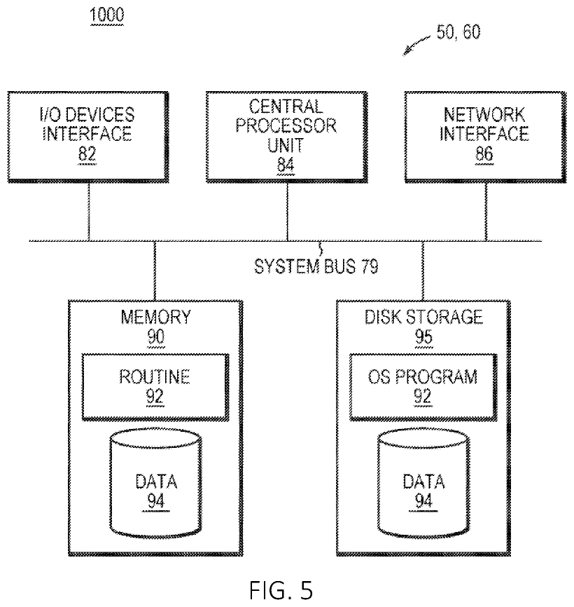

Some embodiments of the system 1000 may include a computer system for adjusting parameters of one or more light sources. The system 1000 may include a plurality of processors 84. The system 1000 may also include a memory 90. The memory 90 may include: (i) computer code instructions stored thereon; and/or (ii) data representing the light reflected by one or more physical objects. The data may include segments including portions of the parameters of one or more light sources. The memory 90 may be operatively coupled to the plurality of processors 84 such that, when executed by the plurality of processors 84, the computer code instructions may cause the computer system 1000 to implement a computing module (the computing module being located on, in, or implemented by any of elements 50, 60, 70 of FIG. 4 or elements 82, 84, 86, 90, 92, 94, 95 of FIG. 5) configured to perform one or more functions.

According to some embodiments, FIG. 5 is a diagram of an example internal structure of a computer (e.g., client processor/device 50 or server computers 60) in the computer system 1000 of FIG. 4. Each computer 50, 60 contains a system bus 79, where a bus is a set of hardware lines used for data transfer among the components of a computer or processing system. The system bus 79 is essentially a shared conduit that connects different elements of a computer system (e.g., processor, disk storage, memory, input/output ports, network ports, etc.) that enables the transfer of information between the elements. Attached to the system bus 79 is an I/O device interface 82 for connecting various input and output devices (e.g., keyboard, mouse, displays, printers, speakers, etc.) to the computer 50, 60. A network interface 86 allows the computer to connect to various other devices attached to a network (e.g., network 70 of FIG. 4). Memory 90 provides volatile storage for computer software instructions 92 and data 94 used to implement some embodiments (e.g., video data stream described herein). Disk storage 95 provides non-volatile storage for computer software instructions 92 and data 94 used to implement an embodiment of the present disclosure. A central processor unit 84 is also attached to the system bus 79 and provides for the execution of computer instructions.

In one embodiment, the processor routines 92 and data 94 are a computer program product (generally referenced 92), including a computer readable medium (e.g., a removable storage medium such as one or more DVD-ROM's, CD-ROM's, diskettes, tapes, etc.) that provides at least a portion of the software instructions for the present disclosure. The computer program product 92 can be installed by any suitable software installation procedure, as is well known in the art. In another embodiment, at least a portion of the software instructions may also be downloaded over a cable, communication and/or wireless connection. Other embodiments may include a computer program propagated signal product 107 (of FIG. 4) embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the routines/program 92 of the present disclosure.

In alternate embodiments, the propagated signal is an analog carrier wave or digital signal carried on the propagated medium. For example, the propagated signal may be a digitized signal propagated over a global network (e.g., the Internet), a telecommunications network, or other network. In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of computer program product 92 is a propagation medium that the computer system 50 may receive and read, such as by receiving the propagation medium and identifying a propagated signal embodied in the propagation medium, as described above for computer program propagated signal product.

Generally speaking, the term “carrier medium” or transient carrier encompasses the foregoing transient signals, propagated signals, propagated medium, storage medium and the like.

Embodiments or aspects thereof may be implemented in the form of hardware (including but not limited to hardware circuitry), firmware, or software. If implemented in software, the software may be stored on any non-transient computer readable medium that is configured to enable a processor to load the software or subsets of instructions thereof. The processor then executes the instructions and is configured to operate or cause an apparatus to operate in a manner as described herein.

Further, hardware, firmware, software, routines, or instructions may be described herein as performing certain actions and/or functions of the data processors. However, it should be appreciated that such descriptions contained herein are merely for convenience and that such actions in fact result from computing devices, processors, controllers, or other devices executing the firmware, software, routines, instructions, etc.

It should be understood that the flow diagrams, block diagrams, and network diagrams may include more or fewer elements, be arranged differently, or be represented differently. But it further should be understood that certain implementations may dictate the block and network diagrams and the number of block and network diagrams illustrating the execution of the embodiments be implemented in a particular way.

Accordingly, further embodiments may also be implemented in a variety of computer architectures, physical, virtual, cloud computers, and/or some combination thereof, and, thus, the data processors described herein are intended for purposes of illustration only and not as a limitation of the embodiments.

While example embodiments have been particularly shown and described, it will be understood by those skilled in the art that various changes in form and details may be made therein without departing from the scope of the embodiments encompassed by the appended claims.

What is claimed is:

1. A method of performing one of a plurality of applications using one or more light sources and a light sensor, the method comprising:
with the one or more light sources, illuminating one or more physical objects;
with the light sensor, sensing light reflected by the one or more physical objects to provide sensed light data; and
configuring a computer processor to automatically adjust one or more parameters of the one or more light sources based on the sensed light data received from the light sensor.

2. The method of claim 1 wherein the adjustment of the one or more parameters of the one or more light sources depends on data retrieved from a non-transitory computer-readable data storage medium by the computer processor, the data having been generated from one or more previous observations.

3. The method of claim 1 wherein the one or more parameters of the one or more light sources includes an intensity parameter.

4. The method of claim 1 wherein the one or more parameters of the one or more light sources includes a spectrum parameter.

5. The method of claim 4 wherein the spectrum parameter is automatically adjusted to control white balance for the light sensor operating in one of a plurality of media with a static or dynamic absorption characteristic.

6. The method of claim 5 wherein the one of a plurality of media includes water or a water-based solution.

7. The method of claim 6 wherein the water-based solution includes salt water.

8. The method of claim 4 wherein the spectrum parameter is automatically adjusted to influence the behavior of the one or more physical objects, or to avoid influencing the behavior of same.

9. The method of claim 1 wherein the parameters of the one or more light sources are automatically adjusted to produce one of a plurality of pre-defined patterns of light.

10. The method of claim 9 wherein the one of a plurality of pre-defined patterns of light includes a grid.

11. The method of claim 10 further comprising configuring the computer processor to analyze the sensed light data to determine a contour of the one or more physical objects.

12. The method of claim 9 wherein the one of a plurality of pre-defined patterns of light includes a checkerboard pattern.

13. The method of claim 12 further comprising configuring the computer processor to analyze the sensed light data to facilitate calibration of the light sensor.

14. A system comprising:
one or more light sources configured to illuminate one or more physical objects;
a light sensor configured to sense light reflected by the one or more physical objects; and;
a computer processor configured to adjust one or more parameters of the one or more light sources based on video data received from the light sensor.

15. The system of claim 14 wherein the one or more light sources are each configured to produce a beam of light having component wavelengths in each of red, green, and blue regions of the visible light spectrum; and further comprising one or more prisms configured to:
disperse the beam of light by wavelength;
direct a portion of the dispersed beam of light having wavelengths in the red region of the visible light spectrum to one or more digital micro-mirror devices;
direct a portion of the dispersed beam of light having wavelengths in the green region of the visible light spectrum to one or more digital micro-mirror devices;
direct a portion of the dispersed beam of light having wavelengths in the blue region of the visible light spectrum to one or more digital micro-mirror devices; and
direct the beam reflected by each one or more digital micro-mirror devices to a projection lens.

16. The system of claim 14 wherein:
at least one light source is configured to produce a beam of light having wavelengths in the red region of the visible light spectrum;
at least one light source is configured to produce a beam of light having wavelengths in the green region of the visible light spectrum;
at least one light source is configured to produce a beam of light having wavelengths in the blue region of the visible light spectrum;
and further comprising:
one or more first prisms configured to direct the beam produced by each light source to one or more digital micro-mirror devices; and
one or more second prisms configured to direct the beam reflected by the one or more digital micro-mirror devices to a projection lens.
